(19) United States
(12) Patent Application Publication
(10) Pub. No.: US 2024/0410660 A1
(43) Pub. Date: Dec. 12, 2024

(54) SUPPORT COMPONENT AND HEAT EXCHANGER SUPPORT OBTAINED FROM AN ASSEMBLY OF SUCH SUPPORT COMPONENTS

(71) Applicant: VALEO SYSTEMES THERMIQUES, Le Mesnil-Saint-Denis (FR)

(72) Inventors: Christophe Denoual, Le Mesnil-Saint-Denis (FR); Frederic Tison, Le Mesnil-Saint-Denis (FR)

(73) Assignee: VALEO SYSTEMES THERMIQUES, Le Mesnil-Saint-Denis (FR)

(21) Appl. No.: 18/701,928

(22) PCT Filed: Oct. 14, 2022
(86) PCT No.: PCT/EP2022/078742

§ 371 Date: Apr. 17, 2024

(30) Foreign Application Priority Data
Oct. 21, 2021 (FR) 2111215

(51) Int. Cl. F28F 9/00

(52) U.S. Cl. CPC F28F 9/001

(57) ABSTRACT

A support component including a U-shaped body is disclosed. The body includes a base extending inside a base plate, a first branch extending in a first plane orthogonal to the base plane, and a second branch extending in a second plane orthogonal to the base plane. The body extends between a first end provided with a first connecting member and a second end provided with a second connecting member. The base includes a first face that intersects the base plane and is provided with a third connecting member and a fourth connecting member. The base includes a second face that is parallel to the base plane and provided with a first arm provided with a fifth connecting member and a second arm provided with a sixth connecting member. The first arm and the second arm are interposed between the first branch and the second branch.

The field of the present invention is that of heat exchanger supports. It relates to a support component. It also relates to a support portion comprising two support components. It also relates to a support comprising two support portions. It also relates to a thermal treatment device comprising such a support and a heat exchanger. It also relates to a thermal treatment module comprising such a thermal treatment device and means for fastening the thermal treatment device to an element of a vehicle, in particular a motor vehicle. It also relates to a method for assembling such a support.

A motor vehicle is commonly equipped with a heating, ventilation and/or air conditioning installation for changing aerothermal parameters of the air contained inside a passenger compartment of the motor vehicle The installation frequently comprises a heat exchanger arranged to allow a thermal transfer between two heat-transfer fluids that flow inside the heat exchanger. Among these heat exchangers, plate heat exchangers are known, obtained from a stack of rectangular plates one on top of the other. The heat exchanger allows a thermal transfer that depends in particular on the volume of the heat exchanger, and therefore the number of stacked plates, and on the dimensions of the plates, such as their length and width.

The heat exchanger is attached to an element of the motor vehicle via a fastening device, such as the one disclosed in FR 3008174, which describes a fastening device comprising a bracket for rigidly connecting and fastening a plate heat exchanger and a pipe. The bracket comprises a main clamping plate capable of being arranged around the heat exchanger and a clasp capable of closing the main clamping plate so as to clamp and rigidly connect the exchanger and the pipe.

The designer of such a heating, ventilation and/or air conditioning installation must have access to several types of heat exchanger with different respective volumes, to meet requirements relating to the size of the motor vehicle, the layout of the heating, ventilation and/or air conditioning installation, and space available to accommodate the heat exchanger. As a result, the designer of such an installation must also have access to as many types of fastening device as types of heat exchanger, which gives rise to a constraint with respect to listing and storage.

The present invention falls within this context and proposes a support component comprising a U-shaped body comprising a base extending inside a base plane, a first branch extending in a first plane orthogonal to the base plane and a second branch extending in a second plane orthogonal to the base plane. The body extends between a first end provided with a first connecting member and a second end provided with a second connecting member. The base comprises a first face that intersects the base plane and is provided with a third connecting member and a fourth connecting member. The base comprises a second face that is parallel to the base plane. The second face is provided with a first arm provided with a fifth connecting member. The second face is provided with a second arm provided with a sixth connecting member. The first arm and the second arm are interposed between the first branch and the second branch.

The support component advantageously comprises at least any one of the following technical features, taken individually or in combination:
the first face is orthogonal to the first plane and the second plane,
the first arm and the fifth connecting member extend in a first direction that is parallel to the first plane and the second plane,
the second arm and the sixth connecting member extend in a second direction that is parallel to the first plane and the second plane,
the base extends mainly along a base direction that is orthogonal to the first plane and the second plane,
the first branch and the second branch are arranged facing each other,
the first branch and the second branch define with the base an inner space forming the inside of the U-shaped body,
the third connecting member extends along a third direction,
the fourth connecting member extends along a fourth direction,
the third direction and the fourth direction are contained inside the base plane,
the third direction and the fourth direction are parallel to each other,
the second face borders the inner space,
the first arm and the second arm extend inside the inner space,
the first arm extends in a direction parallel to the first direction and the second direction,
the first arm and the fifth connecting member extend in a direction parallel to the first direction and the second direction,
the second arm extends in a direction parallel to the first direction and the second direction,
the second arm and the sixth connecting member extend in a direction parallel to the first direction and the second direction,
the first arm is interposed between the second arm and the second branch,
the second arm is interposed between the first arm and the first branch,
the first arm bears a first leg provided with a first fastening groove,
the second arm bears a second leg provided with a second fastening groove,
the first leg and the second leg extend in the same leg direction intersecting the first direction and the second direction,
the first leg comprises a first leg end that is arranged facing the second branch and is equipped with the first fastening groove, which extends in a direction parallel to the leg direction,
the second leg comprises a second leg end that is arranged facing the first branch and is equipped with the second fastening groove, which extends in a direction parallel to the leg direction,
the leg direction is orthogonal to the first plane and the second plane,
the first fastening groove emerges through the first leg end,
the second fastening groove emerges through the second leg end,
the body is provided with at least a pair of fastening sliders comprising at least one first fastening slider provided on either one of the two branches and at least one second slider provided on the base or the other of the two branches,
the first fastening sliders extend in a direction parallel to the first direction and/or the second direction,
the second fastening sliders extend in a direction parallel to the base direction,
the support component is made from a synthetic material,
the support component is a one-piece assembly,
the support component is made in a single molding operation,
the support component comprises a rail interposed between the first arm and the second arm,
the rail extends in a direction parallel to the leg direction,
the support component is made up of two support elements,
the support component is made up of two support elements, a first support element in the form of an elbow extending inside the base plane and the first plane, and a second support element in the form of an elbow extending inside the base plane and the second plane,
the first support element extends between the first end and a third end provided with a seventh connecting member,
the first support element comprises the third connecting element and the second arm,
the second support element extends between the second end and a fourth end provided with an eighth connecting member,
the second support element comprises the fourth connecting element and the first arm,
the seventh connecting member is capable of interacting with the eighth connecting member to form means for assembling the support elements,
the eighth connecting member is in the form of a channel capable of receiving the seventh connecting member, which is in the form of a strip provided on one of its faces with first teeth capable of interacting with second teeth provided on a wall defining the channel.

The present invention also relates to a support portion advantageously comprising two such support components that are identical.

The support portion advantageously comprises at least any one of the following technical features, taken individually or in combination:
the first connecting member of either one of the support components and the second connecting member of the other of the support components are interlocking members capable of interacting with each other to form first means for connecting the support components,
the first connecting member of either one of the support components is in the form of a channel capable of receiving the second connecting member of the other of the support components, which is in the form of a strip provided on one of its faces with first teeth capable of interacting with second teeth provided on a wall defining the channel,
the fifth connecting member of either one of the support components and the sixth connecting member of the other of the support components are interlocking members capable of interacting with each other to form second means for connecting the support components,
the fifth connecting member of either one of the support components is in the form of a channel capable of receiving the sixth connecting member of the other of the support components, which is in the form of a strip provided on one of its faces with first teeth capable of interacting with second teeth provided on a wall defining the channel.

The present invention also relates to a support comprising two such support portions.

The support advantageously comprises at least any one of the following features, taken individually or in combination:
the third connecting member of either one of the support portions and the fourth connecting member of the other of the support portions are interlocking members capable of interacting with each other to form means for attaching the support portions,
the third connecting member of either one of the support portions is in the form of a channel capable of receiving the fourth connecting member of the other of the support portions, which is in the form of a strip provided on one of its faces with first teeth capable of interacting with second teeth provided on a wall defining the channel,
the support is made up in total of four support components identical to each other,
the support is made up in total of four first support elements identical to each other and four second support elements identical to each other.

The present invention also relates to a thermal treatment device comprising such a support and a heat exchanger accommodated inside an inner volume delimited by the support.

The thermal treatment device advantageously comprises at least any one of the following features, taken individually or in combination:
the support defines an inner volume that forms a housing for a heat exchanger, such as a plate exchanger. In other words, the support forms an envelope that surrounds the heat exchanger in the three dimensions of the heat exchanger,
the support comprises openings delimited by the bodies and the arms to allow connectors to emerge out of the inner volume in order to connect the heat exchanger to pipes of a heat-transfer liquid circuit and of a heat-transfer fluid circuit, for example.

The present invention also relates to a thermal treatment module comprising such a thermal treatment device and means for fastening the thermal treatment device to an element of a motor vehicle.

The thermal treatment module advantageously comprises at least any one of the following features, taken individually or in combination:
the fastening means comprise first means for fastening the thermal treatment device to an element of a motor vehicle, these first fastening means comprising first screwing means capable of interacting with first screw orifices made through a fastening plate, the fastening plate and a retaining plate being interposed between a head and a foot of at least one fastening stud the foot of which is received inside the fastening groove,
the fastening means comprise second fastening means comprising a pair of U-shaped fastening members, each fastening member comprising a pair of fingers capable of being inserted inside the first fastening sliders provided on the first branches and second branches, each fastening member comprising second screw orifices that are capable of interacting with second screwing means and are made through fastening tabs provided on the fastening members,
the fastening means comprise third fastening means comprising two pairs of L-shaped fastening brackets, each fastening bracket comprising a first end-piece capable of being inserted inside a first fastening slider provided on the first branch or the second branch, each fastening bracket comprising a second end-piece capable of being inserted inside a second fastening slider provided on the base, each fastening bracket comprising third screw orifices that are capable of interacting with third screwing means and are made through fastening lugs provided on each corner of the fastening brackets.

The present invention also relates to a method for producing such a support, the production method comprising:
a first step comprising a first translation between two support components parallel to the first direction and the second direction, to fit the second connecting members of either one of the support components inside the first connecting members of the other of the support components, and fit the sixth connecting members of either one of the first support components inside the fifth connecting members of the other of the support components, in order to assemble the support portion,
a second step comprising a second translation between two support portions parallel to a third direction in which the third connecting member extends and a fourth direction in which the fourth connecting member extends, to fit the fourth connecting members of either one of the support portions inside the two third connecting members of the other of the support portions, in order to assemble the support portions and form the support.

The production method optionally comprises an initial step carried out prior to the first step and the second step, which initial step comprises a translation of the first support element and/or the second support element parallel to a base direction in which the base of either one of the support elements extends, to fit the seventh connecting member inside the eighth connecting member, and assemble the first support element and the second support element in order to form a support component.

Other features and advantages of the invention will become more clearly apparent from the following description and from a number of exemplary embodiments provided by way of non-limiting indication with reference to the appended schematic drawings, in which:

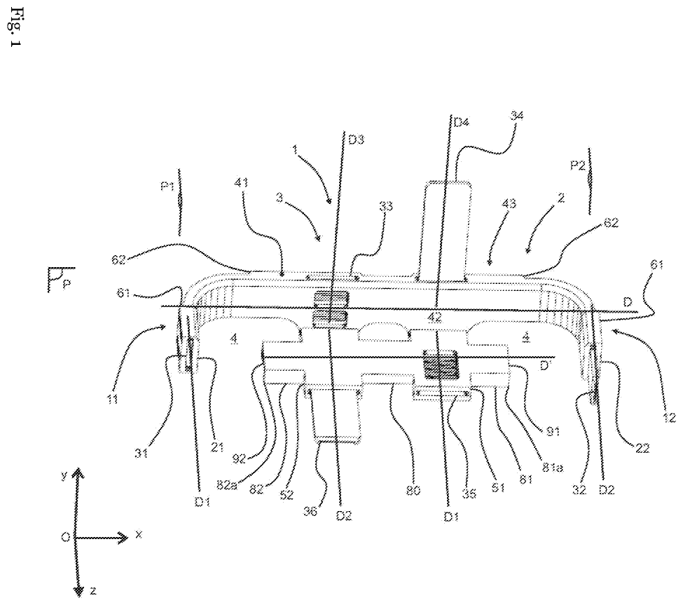

FIG. 1 is a schematic perspective illustration of a first variant embodiment of a support component according to the present invention.

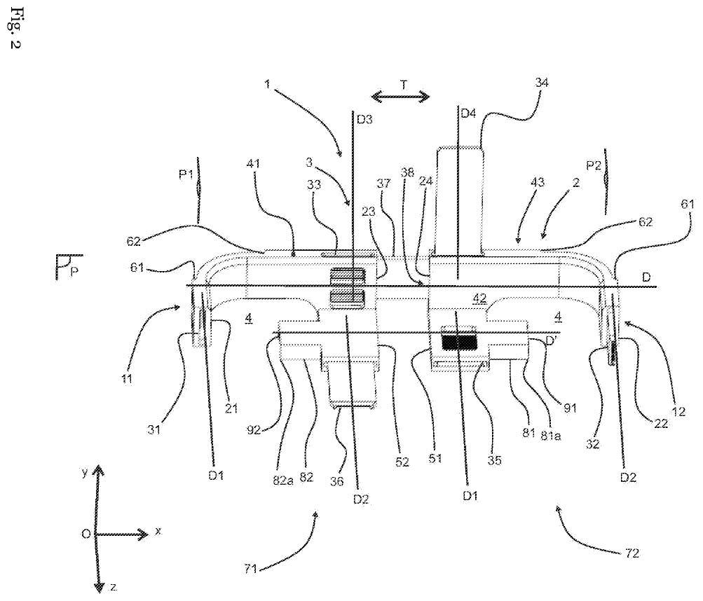

FIG. 2 is a schematic perspective illustration of a second variant embodiment of a support component according to the present invention.

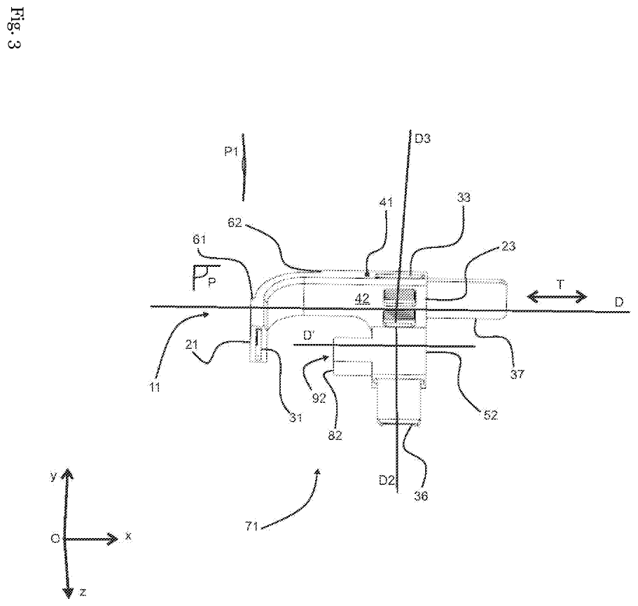

FIG. 3 is a schematic perspective illustration of a first support element of the support component shown in FIG. 2.

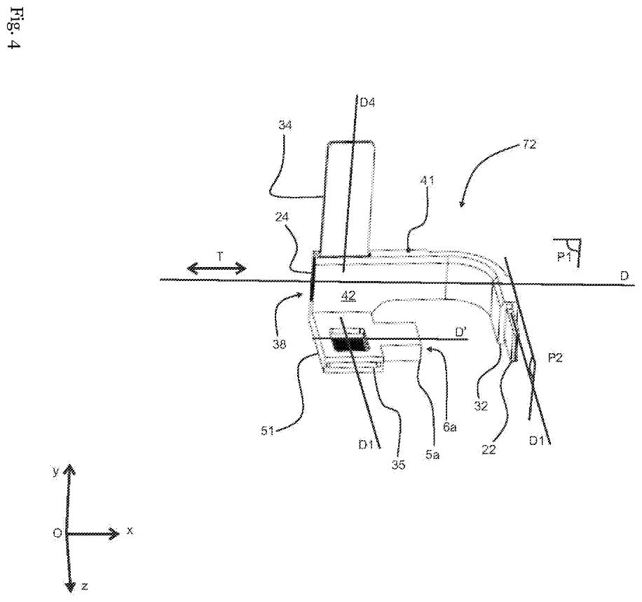

FIG. 4 is a schematic perspective illustration of a second support element of the support component shown in FIG. 2.

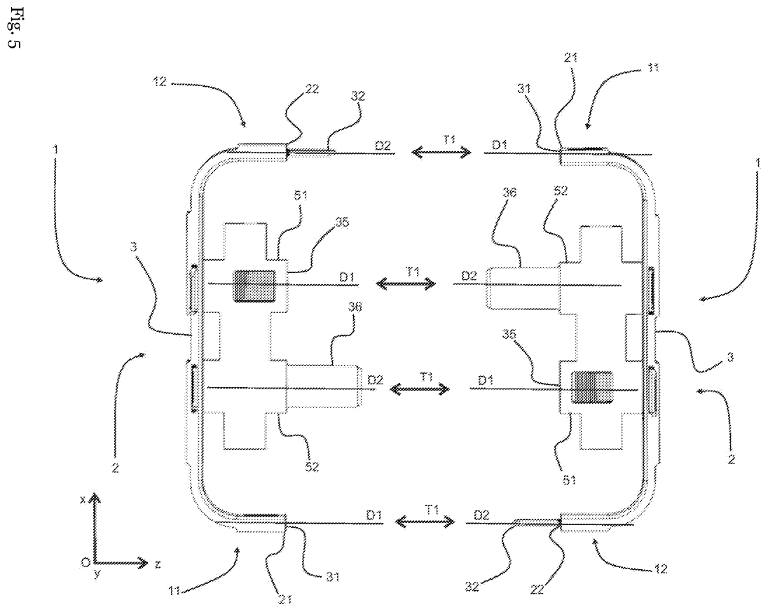

FIG. 5 is a schematic top illustration of two support components shown in FIG. 1 during assembly to form a support portion of the present invention.

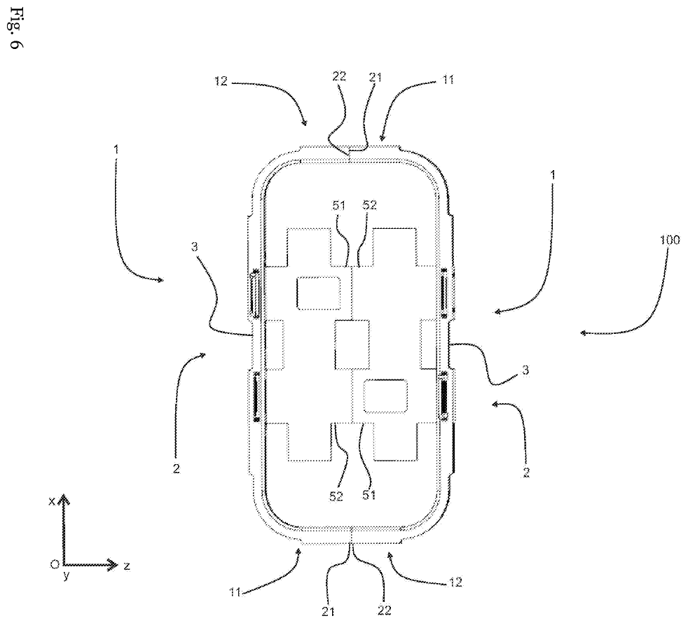

FIG. 6 is a schematic top illustration of the support portion obtained after assembly of the two support components shown in FIG. 5.

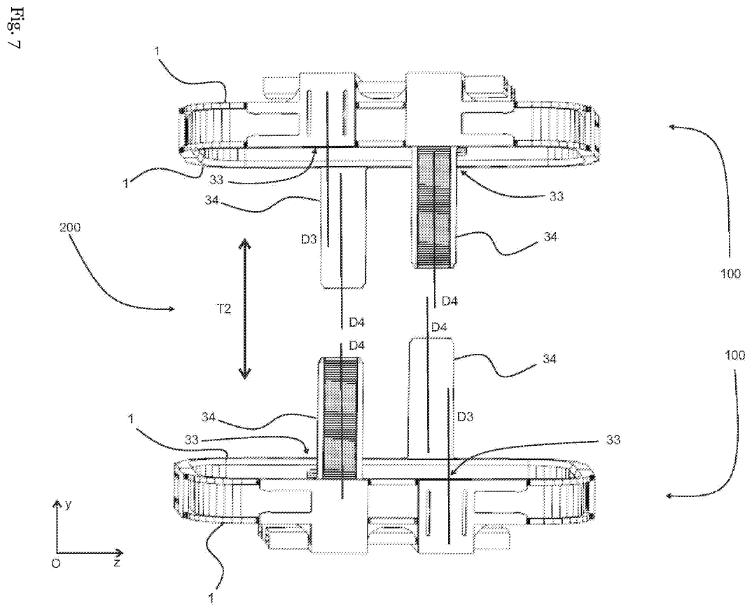

FIG. 7 is a schematic side illustration of two support portions shown in FIG. 6 during assembly to form a support of the present invention.

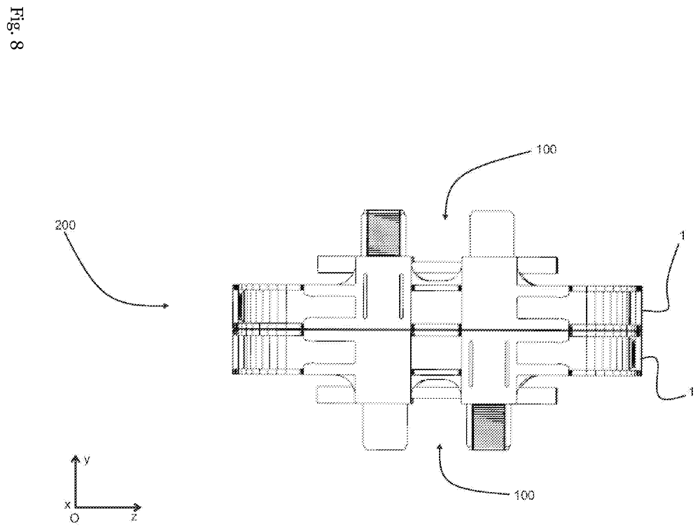

FIG. 8 is a schematic side illustration of the support obtained after assembly of the two support portions shown in FIG. 7.

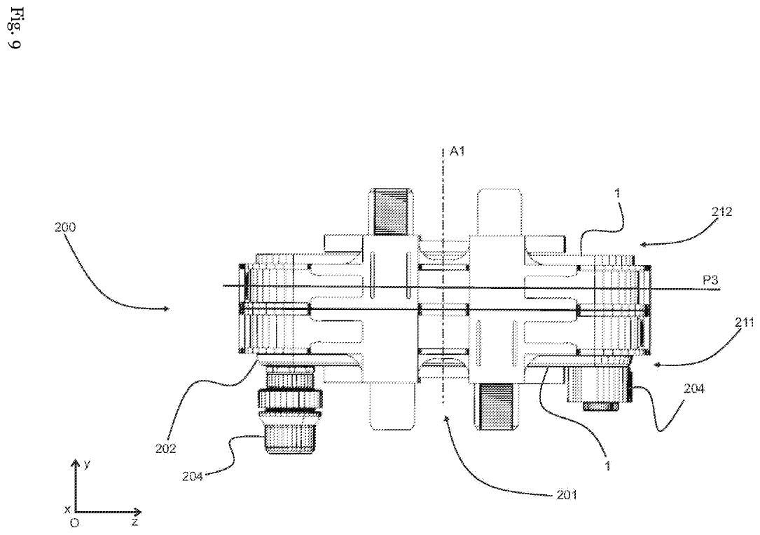

FIG. 9 is a schematic side illustration of a thermal treatment device of the present invention comprising a support shown in FIG. 8, which houses a heat exchanger.

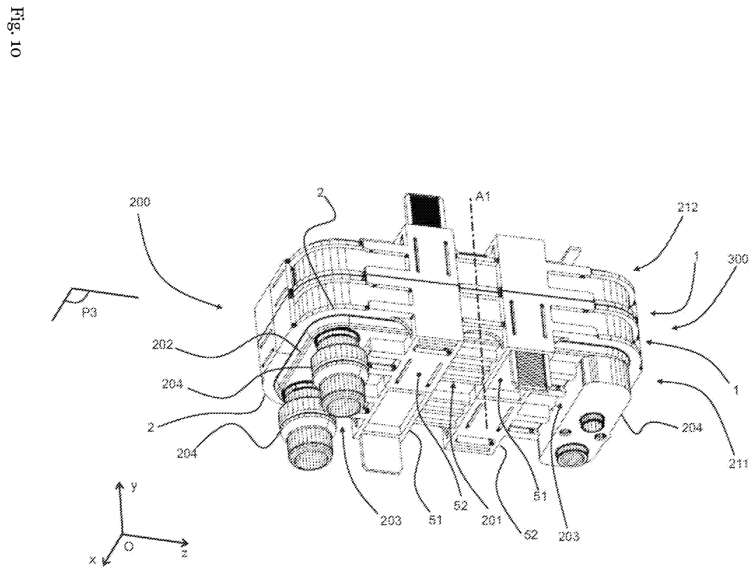

FIG. 10 is a schematic perspective bottom illustration of the thermal treatment device shown in FIG. 9.

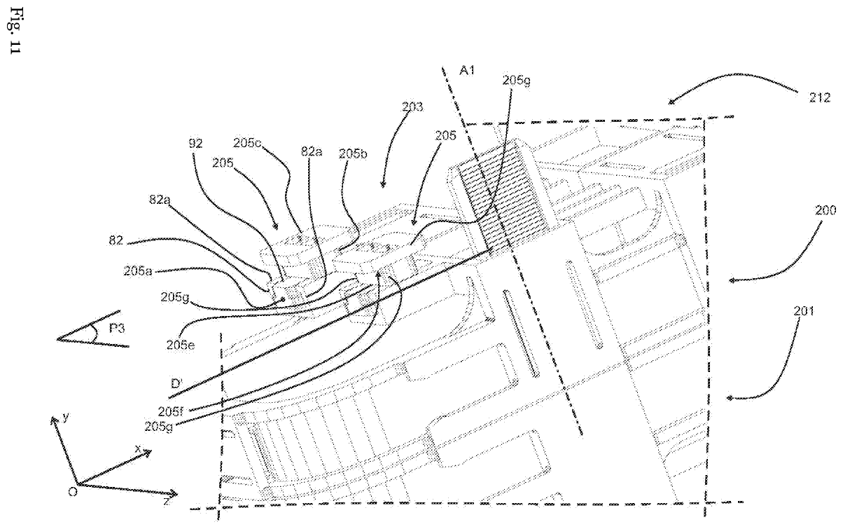

FIG. 11 is a detail top view of the thermal treatment device shown in FIGS. 9 and 10.

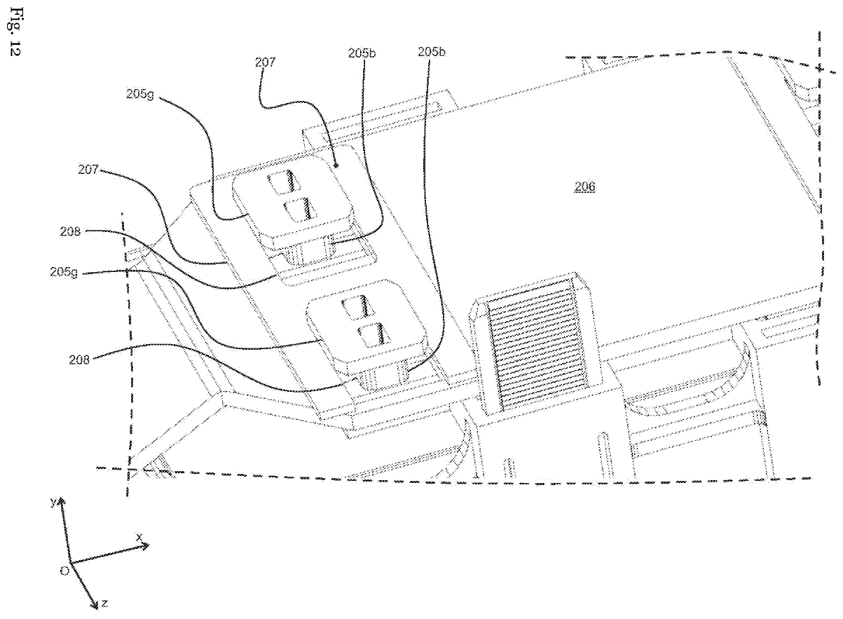

FIG. 12 is another detail top view of the thermal treatment device shown in FIGS. 9 and 10.

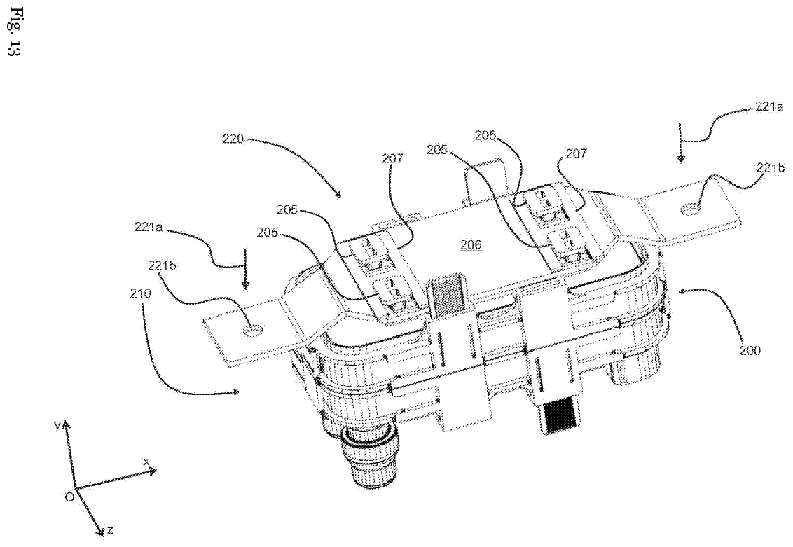

FIG. 13 is a schematic perspective illustration of a first variant embodiment of a thermal treatment module comprising a thermal treatment device illustrated in FIGS. 9 and 10 and first means for fastening the thermal treatment device to an element of a motor vehicle.

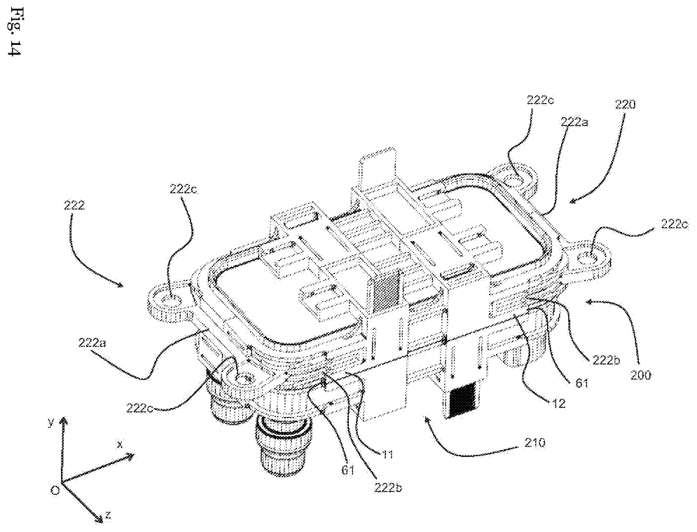

FIG. 14 is a schematic perspective illustration of a second variant embodiment of a thermal treatment module comprising a thermal treatment device illustrated in FIGS. 9 and 10 and second means for fastening the thermal treatment device to an element of a motor vehicle.

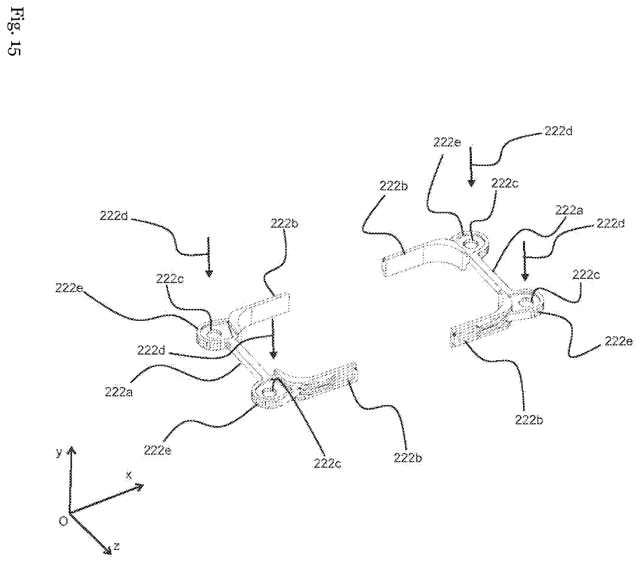

FIG. 15 is a partial schematic perspective illustration of the second fastening means shown in FIG. 14.

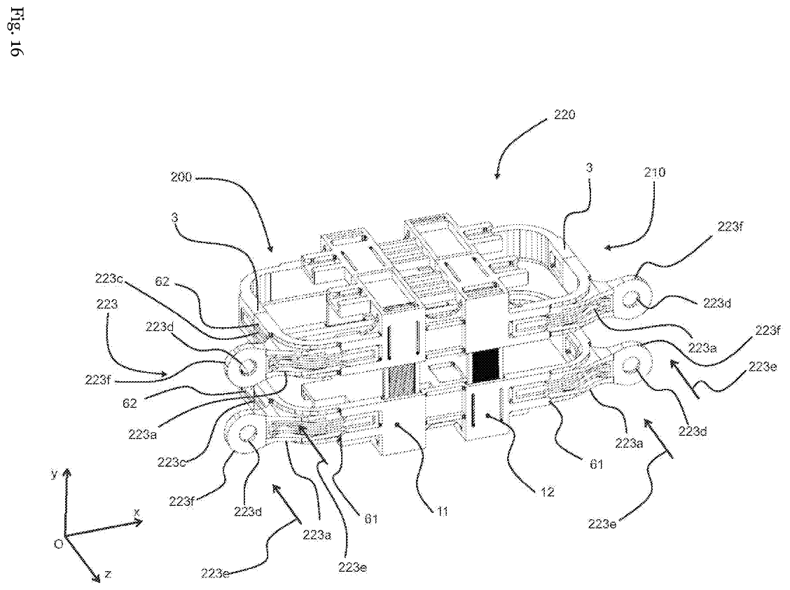

FIG. 16 is a schematic perspective illustration of a third variant embodiment of a thermal treatment module comprising a thermal treatment device illustrated in FIGS. 9 and 10 and third means for fastening the thermal treatment device to an element of a motor vehicle.

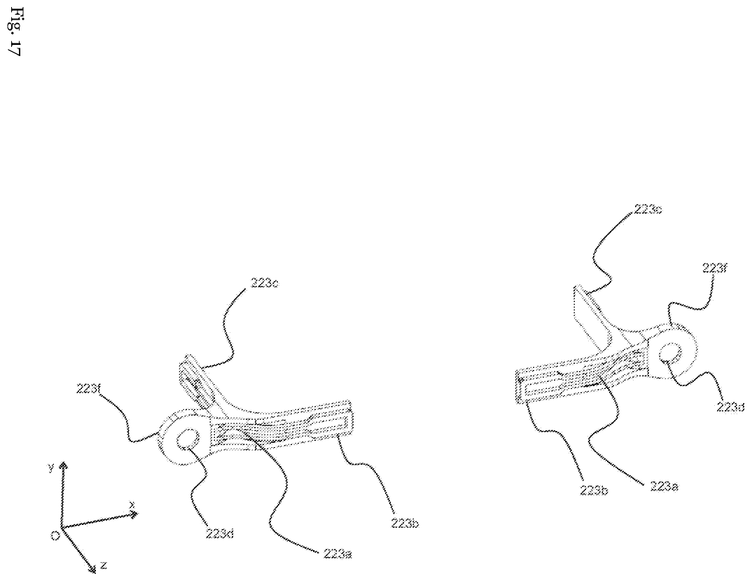

FIG. 17 is a partial schematic perspective illustration of the third fastening means shown in FIG. 16.

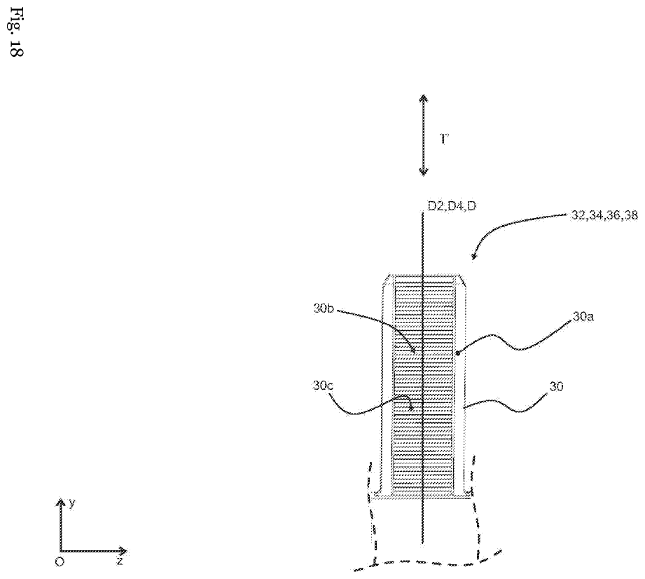

FIG. 18 is a schematic front illustration of a male connecting member of the support component shown in FIG. 1, of the first support element shown in FIG. 3, and of the second support element shown in FIG. 4.

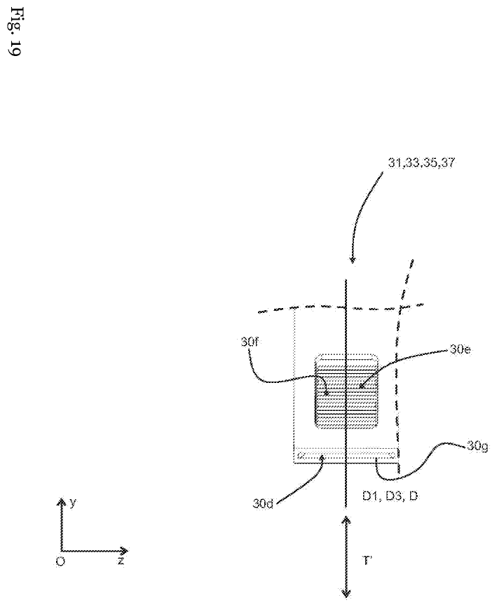

FIG. 19 is a schematic perspective illustration of a female connecting member of the support component shown in FIG. 1, of the first support element shown in FIG. 3, and of the second support element shown in FIG. 4.

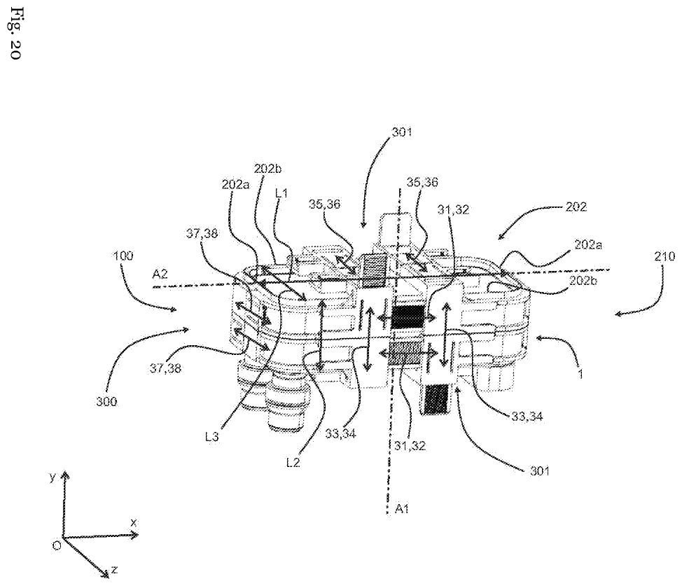

FIG. 20 is a schematic illustration of the thermal treatment device shown in FIGS. 9 and 10.

In the figures, the elements shown are illustrated in an orthonormal coordinate system Oxyz that comprises a vertical axis Oy and a horizontal plane Oxz orthogonal to the vertical axis Oy. In the description hereinafter, the qualifiers “upper” and “lower” thus indicate a relative position of elements along the vertical axis Oy. Likewise, in the description hereinafter, the qualifier “lateral” indicates a relative position of elements on either side of the vertical axis Oy.

It will also be noted that the terms first, second, third, etc. are ordinal numeral adjectives that only qualify the terms to which they refer, and do not define any hierarchy or predominance of one term with respect to the others. The main aim of these ordinal numeral adjectives is to enumerate them, either because they are different from each other, or because they are identical but there is a plurality of them.

FIGS. 1 and 2 show a support component 1 of the present invention. The support component 1 is preferably made from a synthetic material, such as a polyamide or similar. The support component is for example made in a single molding operation.

The support component 1 comprises a U-shaped body 2. The support component 1 thus comprises a base 3 that extends inside a base plane P parallel to the plane Oxy and two branches 11, 12 parallel to each other, a first branch 11 that extends in a first plane P1 orthogonal to the base plane P and a second branch 12 that extends in a second plane P2 different from the first plane P1 and is orthogonal to the base plane P. More particularly, the base 3 mainly extends along a base direction D, parallel to the direction Ox. The first branch 11 mainly extends in a first direction D1 orthogonal to the base direction D and parallel to the axis Oz. The second branch 12 mainly extends along a second direction D2, parallel to the first direction D1. It will be understood that in a plane of section parallel to the plane Oxz, the body 2 has a U-shaped cross-section.

It will also be noted that the first branch 11 and the second branch 12 are arranged facing each other so that the first branch 11 and the second branch 12 define, with the base 3, an inner space 4 forming the inside of the U.

The body 2 extends between a first end 21 and a second end 22. The first end 21 is equipped with a first connecting member 31 and the second end 22 is provided with a second connecting member 32. The first connecting member 31 extends along the first direction D1 and the second connecting member 32 extends along the second direction D2. The first connecting member 31 is a female interlocking member capable of interacting with the second connecting member 32, which is in the form of a male interlocking member complementary to the female interlocking member. More particularly, and as described below, the first connecting member 31 of a support component 1 is capable of interacting with a second connecting member 32 of another support component 1, and vice versa, to form first means 31, 32 for connecting two support components 1 to each other.

The base 3 comprises a first face 41 that extends in a plane intersecting the base plane P. Preferably, the first face 41 extends in a plane orthogonal to the first plane P1 and the second plane P2. The first face 41 is provided with a third connecting member 33 and a fourth connecting member 34. The third connecting member 33 extends along a third direction D3 and the fourth connecting member 34 extends in a fourth direction D4. The third direction D3 and the fourth direction D4 are contained inside the base plane P. The third direction D3 and the fourth direction D4 are parallel to each other and parallel to the direction Oy. The third connecting member 33 is a female interlocking member capable of interacting with the fourth connecting member 34, which is in the form of a male interlocking member complementary to the female interlocking member. More particularly, and as described below, the third connecting member 33 of a support component 1 is capable of interacting with a fourth connecting member 34 of another support component 1, and vice versa, to form means 33, 34 for attaching two support components 1 to each other.

The base 3 comprises a second face 42 that extends inside a plane parallel to the base plane P. The second face 42 borders the inner space 4. The second face 42 is provided with a first arm 51 and a second arm 52. The first arm 51 and the second arm 52 extend inside the inner space 4. The first arm 51 extends in a direction parallel to the first direction D1 and the second direction D2. The second arm 52 extends in a direction parallel to the first direction D1 and the second direction D2. In a plane parallel to the plane Oxz, the first arm 51 is interposed between the second arm 52 and the second branch 12, and the second arm 52 is interposed between the first arm 51 and the first branch 11. The first arm 51 is equipped with a fifth connecting member 35 that extends in a direction parallel to the first direction D1 and the second direction D2. The second arm 52 is equipped with a sixth connecting member 36 that extends in a direction parallel to the first direction D1 and the second direction D2. The fifth connecting member 35 is a female interlocking member capable of interacting with the sixth connecting member 36, which is in the form of a male interlocking member complementary to the female interlocking member. More particularly, and as described below, the fifth connecting member 35 of a support component 1 is capable of interacting with a sixth connecting member 36 of another support component 1, and vice versa, to form second means 35, 36 for connecting two support components 1 to each other.

It will be noted that the first arm 51 and the fifth connecting member 35 extend jointly in the same direction parallel to the first direction D1. It will also be noted that the second arm 52 and the sixth connecting member 36 extend jointly in the same direction parallel to the second direction D2.

The first arm 51 is equipped with a first leg 81 that extends inside the inner space 4 toward the second branch 12, along a leg direction D′ parallel to the base direction D. The first leg 81 comprises a first leg end 81a that is arranged facing the second branch 12 and is equipped with a first fastening groove 91, which extends in a direction parallel to the leg direction D′.

The second arm 52 is equipped with a second leg 82 that extends inside the inner space 4 toward the first branch 11, along the leg direction D′. The second leg 82 comprises a second leg end 82a that is arranged facing the first branch 11 and is equipped with a second fastening groove 92, which extends in a direction parallel to the leg direction D′.

Preferably, the first fastening groove 91 and the second fastening groove 92 extend in the same direction, which is parallel to the leg direction D′. It will be noted that the first fastening groove 91 emerges through the first leg end 81a and the second fastening groove 92 emerges through the second leg end 82a.

The body 2 is provided with two pairs of fastening sliders 61, 62. Each pair of fastening sliders 61, 62 comprises a first fastening slider 61 provided on one of the branches 11, 12 and a second fastening slider 62 provided on the base 3. The first fastening sliders 61 extend in a direction parallel to the first direction D1 and/or the second direction D2. The second fastening sliders 62 extend in a direction parallel to the base direction D.

According to a first variant embodiment illustrated in FIG. 1, the support component 1 is a one-piece assembly, for example made from a plastic material in a single molding operation. It will be understood that the one-piece nature of the support component 1 means that none of the constituent parts of the support component 1 can be separated from the support component 1 without the deterioration thereof, or even damage thereto.

According to this variant, a rail 80 is interposed between the first arm 51 and the second arm 52, the rail 80 extending in a direction parallel to the leg direction D′.

According to a second variant embodiment illustrated in FIG. 2, the support component 1 is made up in total of two support elements 71, 72, a first support element 71 illustrated in FIG. 3, and a second support element 72, illustrated in FIG. 4. Each support element 71, 72 is a one-piece assembly, for example made from a plastic material in a single molding operation. It will be understood that the one-piece nature of the support element 71, 72 means that none of the constituent parts of the support element 71, 72 can be separated from the support element 71, 72 without the deterioration thereof, or even damage thereto.

The first support element 71 is in the form of an elbow extending inside the base plane P and the first plane P1. The first support element 71 extends between the first end 21 and a third end 23 orthogonal to the base plane P. The third end 23 is provided with a seventh connecting member 37. In general, the first support element 71 is a first half of the support component 1, the first support element 71 comprising the third connecting member 33, the second arm 52, a first fastening slider 61 and a second fastening slider 62.

The second support element 72 is in the form of an elbow extending inside the base plane P and the second plane P2. The second support element 72 extends between the second end 22 and a fourth end 24 orthogonal to the base plane P. The fourth end 24 is provided with an eighth connecting member 38. In general, the second support element 72 is a second half of the support component 1, the second support element 72 comprising the fourth connecting member 34, the first arm 51, a first fastening slider 61 and a second fastening slider 62.

The seventh connecting member 37 is a male interlocking member capable of interacting with the eighth connecting member 38, which is in the form of a female interlocking member complementary to the male interlocking member. More particularly, and as described below, the seventh connecting member 37 of a support element 71, 72 is capable of interacting with the eighth connecting member 38 of another support element 71, 72 and vice versa, to form means 37, 38 for assembling two support elements 71, 72 with each other.

It will be understood that through a translation T of the first support element 71 and/or the second support element 72 toward each other, this translation T being parallel to the base direction D, it is possible to fit the seventh connecting member 37 inside the eighth connecting member 38, in order to assemble the first support element 71 and the second support element 72.

FIG. 5 shows a support portion 100 during assembly, the support portion 100 consisting in total of two support components 1, a first support component 1 and a second support component 1, which are identical to each other not only in their shape, as described above, but also in their size. It will be observed that through a first translation T1 of the first support component 1 and/or of the second support component 1 toward each other, this first translation movement T1 being parallel to the first direction D1 and the second direction D2, it is possible to fit the second connecting member 32 of the first support component 1 inside the first connecting member 31 of the second support component 1, and simultaneously to fit the second connecting member 32 of the second support component 1 inside the first connecting member 31 of the first support component 1, and simultaneously to fit the sixth connecting member 36 of the first support component 1 inside the fifth connecting member 35 of the second support component 1, and simultaneously to fit the sixth connecting member 36 of the second support component 1 inside the fifth connecting member 35 of the first support component 1, in order to assemble the two support components 1 with each other and form the support portion 100 as illustrated in FIG. 6.

It will be noted that the support components 1 are assembled with each other via four robust connecting means, two first connecting means 31, 32 and two second connecting means 35, 36.

FIG. 7 shows a support 200 during assembly, the support 200 consisting in total of two support portions 100, a first support portion 100 and a second support portion 100. It will be observed that through a second translation T2 of the first support portion 100 and/or of the second support portion 100 toward each other, this second translation T2 being parallel to the third direction D3 and the fourth direction D4, it is possible to fit the two fourth connecting members 34 of the first support portion 100 respectively inside the two third connecting members 33 of the second support portion 100, and simultaneously to fit the two fourth connecting members 34 of the second support portion 100 respectively inside the two third connecting members 33 of the first support portion 100, in order to assemble the two support portions 100 with each other and form the support 200, as illustrated in FIG. 8.

It will be noted that the support portions 100 are assembled with each other via four attachment means 33, 34 that are identical to each other. It will also be noted that the support 200 consists in total of either four support components 1 that are identical to each other, such as the one shown in FIG. 1, or four first support elements 71 that are identical to each other, such as the one shown in FIG. 3, and four second support elements 72 that are identical to each other, such as the one shown in FIG. 4. It will be understood that this identical nature facilitates the manufacturing and assembly of these elements with each other.

In FIGS. 9 and 10, the support 200 defines an inner volume 201 that forms a housing for a heat exchanger 202, such as in particular a plate exchanger. In other words, the support 200 forms an envelope that surrounds the heat exchanger 202 in the three dimensions of the heat exchanger 202. Again in other words, a thermal treatment device 210 of the present invention comprises a support 200 that forms a framework surrounding the heat exchanger 202. It will be noted that the support 200 comprises openings 203 delimited by the bodies 2 and the arms 51, 52 to allow connectors 204, such as hydraulic connectors, to emerge out of the inner volume 201 in order to connect the heat exchanger 202 to pipes of a heat-transfer liquid circuit and of a heat-transfer fluid circuit, for example. It will be noted that these openings 203 are provided for example on a first face 211 of the support 200 extending in a plane parallel to the plane Oxz. The first face 211 is preferably orthogonal to a stacking axis A1 of plates 300 forming the heat exchanger 202, the plates 300 mainly extending in a plate plane P3 orthogonal to the stacking axis A1.

In FIG. 11, a second face 212 of the support 200, opposite and parallel to the first face 211, also comprises openings 203 to allow fastening studs 205 to emerge out of the inner volume 201. Each fastening stud 205 comprises a foot 205a that is shaped so that it can slide inside one of the fastening grooves 92 of the legs 82. To this end, the foot 205a has, in a plane orthogonal to the leg direction D′, a T-shaped profile that emerges through an upper face 82a of the leg 82. Each fastening stud 205 comprises a stem 205b that extends in a plane orthogonal to the leg direction D′ between a lower edge 205e rigidly connected to the foot 205a and an upper edge 205f rigidly connected to a head 205g that lies above the stem 205b. The stem 205b comprises lateral edges 205g that lie above the upper face 82a of the leg 82 so that the lower edge 205e of the foot 205a level with the lateral edges 205g circulates against the upper face 82a and holds the foot 205a inside the fastening groove 92.

In FIG. 12, a fastening plate 206 and a retaining plate 207 comprising retaining orifices 208 are intended to be interposed between the head 205g and the foot 205a of the fastening stud 205. More particularly, the fastening plate 206 is interposed between the retaining plate 207 and the foot 205a of the fastening stud 205, while the retaining plate 207 is interposed between the head 205g of the fastening stud 205 and the fastening plate 206. It will be understood that the retaining orifices 208 allow through the heads 205g, which are T-shaped, in order to immobilize the fastening plate 206 and the retaining plate 207, one of the retaining orifices 208 emerging onto a rim of the retaining plate 207.

In FIG. 13, a thermal treatment module 220 of the present invention comprises a thermal treatment device 210 and first means 221 for fastening the thermal treatment device 210 into an element of a motor vehicle, these first fastening means 221 comprising for example first screwing means 221a capable of interacting with first screw holes 221b made through the fastening plate 206.

These provisions allow the simple, rapid fastening of the thermal treatment module 220 to a wall of the motor vehicle extending for example in a plane parallel to the plane Oxz. It will however be noted that the fastening plate 206 is able to have almost any configuration to allow the thermal treatment module 220 to be fastened to any wall of the motor vehicle.

In FIG. 14, a thermal treatment module 220 of the present invention comprises a thermal treatment device 210 and second means 222 for fastening the thermal treatment device 210 into an element of a motor vehicle, these second fastening means 222 comprising a pair of U-shaped fastening members 222a.

In FIG. 15, each fastening member 222a comprises a pair of fingers 222b capable of being inserted inside the first fastening sliders 61 provided on the first branches 11 and the second branches 12, visible in FIG. 14. Each fastening member 222a also comprises second screw holes 222c capable of interacting with second screwing means 222d. The second screw holes 222c are for example made through fastening tabs 222e provided on each corner of the fastening members 222a, situated at the intersection between the base and the branches of the U-shaped fastening members 222a. It will be noted that each finger 222b is preferably provided with a deformable pawl allowing the insertion and then the immobilization of the finger 222b inside the fastening slider 61.

These provisions allow the simple, rapid fastening of the thermal treatment module 220 to a wall of the motor vehicle extending for example in a plane parallel to the plane Oxz.

In FIG. 16, a thermal treatment module 220 of the present invention comprises a thermal treatment device 210 (the heat exchanger of which is not shown) and third means 223 for fastening the thermal treatment device 210 to an element of a motor vehicle, these third fastening means 223 comprising two pairs of L-shaped fastening brackets 223a.

In FIG. 17, each fastening bracket 223a comprises a first end-piece 223b capable of being inserted inside a first fastening slider 61 provided on the first branch 11 or the second branch 12, visible in FIG. 15, of two bodies 2 butted together. Each fastening bracket 223a comprises a second end-piece 223c capable of being inserted inside a second fastening slider 62 provided on the base 3, visible in FIG. 16. It will be noted that each end-piece 223b, 223c is preferably provided with a deformable pawl allowing the insertion and then the immobilization of the end-piece 223b, 223c inside the fastening slider 61, 62.

Each fastening bracket 223a also comprises third screw holes 223d capable of interacting with third screwing means 223e. The third screw holes 223d are for example made through fastening lugs 223f provided on each corner of the fastening brackets 223a.

These provisions allow the simple, rapid fastening of the thermal treatment module 220 to a wall of the motor vehicle extending for example in a plane parallel to the plane Oxy.

FIG. 18 shows a male connecting member 32, 34, 36, 38 illustrating any one of the second connecting member 32, the fourth connecting member 34, the sixth connecting member 36, and the eighth connecting member 38. This male connecting member 32, 34, 36, 38 is in the form of a strip 30 that comprises on one of its faces 30a a central recess 30b that extends in the same direction D2, D4, D as the male connecting member 32, 34, 36, 38. The central recess 30b is provided with a plurality of first teeth 30c that extend in a direction orthogonal to the direction D2, D4, D in which this male connecting member 32, 34, 36, 38 extends.

FIG. 19 shows a female connecting member 31, 33, 35, 37 illustrating any one of the first connecting member 31, the third connecting member 33, the fifth connecting member 35, and the seventh connecting member 37. This female connecting member 31, 33, 35, 37 is in the form of a channel 30d delimited by at least one wall 30e provided with second teeth 30f that extend in a direction orthogonal to the direction D1, D3, D in which this female connecting member 31, 33, 35, 37 extends.

The channel 30d is provided with an opening 30g through which the strip 30 is capable of being inserted through a second translation T′ parallel to the directions in which the male connecting member 32, 34, 36, 38 and the female connecting member 31, 33, 35, 37 extend. Such insertion makes it possible to implement the first means 31, 32 for connecting the support components 1, the means 33, 34 for attaching the support portions 100, the second means 35, 36 for connecting the support components 1, and the means 37, 38 for assembling two support elements 71, 72.

It will be understood that the male connecting member 32, 34, 36, 38 and the female connecting member 31, 33, 35, 37 form a retaining pawl that permits the insertion of the strip 30 into the channel 30d and prevents the removal of the strip 30 from the channel 30d.

In FIG. 20, it will be understood that the insertion of the first connecting members 31 inside the second connecting members 32 of the first means 31, 32 for connecting the support components 1 is adjusted depending on a length L1 of the heat exchanger 202, this length L1 being taken in a direction of elongation A2 of the heat exchanger 202 and/or of the plates 300 forming the heat exchanger 202, between two lateral edges 202a of the heat exchanger 202. It will likewise be understood that the thermal treatment device 210 is capable of housing a heat exchanger 202 with almost any length L1.

It will also be understood that the insertion of the third connecting members 33 inside the fourth connecting members 34 of the means 33, 34 for attaching the support portions 100 is adjusted depending on the thickness L2 of the heat exchanger 202, this thickness L2 being taken between the end checks 301 of the heat exchanger 202 in a direction perpendicular to the direction of elongation A2 of the heat exchanger 202 and/or of the plates 300. It will likewise be understood that the thermal treatment device 210 is capable of housing a heat exchanger 202 with almost any thickness L2, and therefore a heat exchanger 202 comprising almost any number of plates 300.

It will also be understood that the insertion of the fifth connecting members 35 inside the sixth connecting members 36 of the second means 35, 36 for connecting the support components 1, and optionally the seventh connecting members 37 inside the eighth connecting members 38 of the means 37, 38 for assembling the support elements 71, 72, is adjusted depending on a width L3 of the heat exchanger 202, this width L3 being taken in a direction perpendicular to the direction of elongation A2 of the heat exchanger 202 and/or of the plates 300 between two longitudinal edges 202b of the heat exchanger 202. It will likewise be understood that the thermal treatment device 210 is capable of housing a heat exchanger 202 with almost any width L3.

All of these provisions are such that through a plurality of support components 1 that are identical to each other, or through a plurality of first support elements 71 that are identical to each other and a plurality of second support elements 72 that are identical to each other, the support 200 obtained is able to house in its inner volume 201 a heat exchanger 202 of any volume, and more particularly comprising any number of plates 300.

More particularly, all of these provisions are such that through four support components 1 that are identical to each other, or through four first support elements 71 that are identical to each other and four second support elements 72 that are identical to each other, the support 200 obtained is able to house in its inner volume 201 a heat exchanger 202 of any volume, and more particularly comprising any number of plates 300.

1. A support component comprising
a U-shaped body, the body comprising:
a base extending inside a base plane,
a first branch extending in a first plane orthogonal to the base plane, and
a second branch extending in a second plane orthogonal to the base plane,
wherein the body extends between a first end provided with a first connecting member and a second end provided with a second connecting member,
the base comprising a first face that intersects the base plane and is provided with a third connecting member and a fourth connecting member,
the base comprising a second face that is parallel to the base plane and provided with a first arm provided with a fifth connecting member and a second arm provided with a sixth connecting member,
wherein the first arm and the second arm are interposed between the first branch and the second branch.

2. The support component as claimed in claim 1,
wherein the first arm and the fifth connecting member extend in a first direction that is parallel to the first plane and the second plane.

3. The support component as claimed in claim 1,
wherein the second arm and the sixth connecting member extend in a second direction that is parallel to the first plane and the second plane.

4. The support component as claimed in claim 2,
wherein the first arm bears a first leg provided with a first fastening groove and the second arm bears a second leg provided with a second fastening groove,
wherein the first leg and the second leg extend in the same leg direction intersecting the first direction and the second direction.

5. The support component as claimed in claim 1,
wherein the body is provided with at least a pair of fastening sliders comprising at least one first fastening slider provided on either one of the two branches and at least one second slider provided on the base or the other of the two branches.

6. The support component as claimed in claim 1,
wherein the support component consists of two support elements,
wherein the two support elements are:
a first support element in the form of an elbow extending inside the base plane and the first plane,
wherein the first support element extends between the first end and a third end provided with a seventh connecting member,
the first support element comprising the third connecting member and the second arm, and
a second support element in the form of an elbow extending inside the base plane and the second plane,
wherein the second support element extends between the second end and a fourth end provided with an eighth connecting member,
the second support element comprising the fourth connecting member and the first arm,
wherein the seventh connecting member is capable of interacting with the eighth connecting member in order to form means for assembling the support elements.

7. The support component as claimed in claim 6,
wherein the eighth connecting member is in the form of a channel capable of receiving the seventh connecting member, which is in the form of a strip provided on one of its faces with first teeth capable of interacting with second teeth provided on a wall defining the channel.

8. A support portion comprising two identical support components as claimed in claim 1,
wherein the first connecting member of either one of the support components and the second connecting member of the other of the support components are interlocking members capable of interacting with each other to form first means for connecting the support components.

9. The support portion as claimed in claim 8,
wherein the first connecting member of either one of the support components is in the form of a channel capable of receiving the second connecting member of the other of the support components, which is in the form of a strip provided on one of its faces with first teeth capable of interacting with second teeth provided on a wall defining the channel.

10. The support portion as claimed in claim 8,
wherein the fifth connecting member of either one of the support components and the sixth connecting member of the other of the support components are interlocking members capable of interacting with each other to form second means for connecting the support components.

11. The support portion as claimed in claim 10,
wherein the fifth connecting member of either one of the support components is in the form of a channel capable of receiving the sixth connecting member of the other of the support components, which is in the form of a strip provided on one of its faces with first teeth capable of interacting with second teeth provided on a wall defining the channel.

12. A support comprising two support portions as claimed in claim 8,
wherein the third connecting member of either one of the support portions and the fourth connecting member of the other of the support portions are interlocking members capable of interacting with each other to form means for attaching the support portions.

13. The support as claimed in claim 12,
wherein the third connecting member of either one of the support portions is in the form of a channel capable of receiving the fourth connecting member of the other of the support portions, which is in the form of a strip provided on one of its faces with first teeth capable of interacting with second teeth provided on a wall defining the channel.

14. A thermal treatment device comprising: a support as claimed in claim 12; and a heat exchanger housed inside an inner volume delimited by the support.

15. A thermal treatment module comprising: a thermal treatment device as claimed in claim 14; and means for fastening the thermal treatment device to an element of a motor vehicle.
